(19) United States
(12) Patent Application Publication
(10) Pub. No.: US 2019/0042451 A1
(43) Pub. Date: Feb. 7, 2019

(54) EFFICIENT USAGE OF BANDWIDTH OF DEVICES IN CACHE APPLICATIONS

(71) Applicant: INTEL CORPORATION, Santa Clara, CA (US)

(72) Inventors: DAVID J. LEONE, CHANDLER, AZ (US); ANDRZEJ JAKOWSKI, CHANDLER, UT (US)

(21) Appl. No.: 15/900,638

(22) Filed: Feb. 20, 2018

(51) Int. Cl. G06F 12/0888; G06F 12/0891

(52) U.S. Cl. CPC G06F 12/0888; G06F 2212/608; G06F 2212/1024; G06F 12/0891

(57) ABSTRACT

A memory storage control apparatus, system, and method are described. An apparatus can include a memory controller configured to couple to a primary memory resource (PMR) and to a cache memory resource (CMR) and is configured to receive a read or write data request associated with particular data. For a read data request, the memory controller is configured to perform a lookup of a cache table mapped to the CMR for a copy of the particular data, and determine, if the lookup returns a hit and the particular data is not altered compared to the copy of the particular data, whether the CMR is saturated. For a write data request, the memory controller is configured to determine whether the CMR is saturated with data requests. In accordance with a determination that the CMR is saturated with data requests, the bypass the CMR, and send the data request to the PMR.

### BACKGROUND

Computer systems can employ a variety of storage methods to store data both for short term use and long-term use. Storage methods that allow faster storage and retrieval of data results in more efficient computer system operation, all other things being equal. One method to improve the performance of non-volatile memory is to store at least some of the data in a cache. A cache is a memory storage resource coupled to a primary memory resources that generally performs data operations faster than the storage resource to which it is attached. Data that is frequently accessed may be stored in the cache, allowing for faster response rates for that data and for the system overall.

However, to be cost-effective and to enable efficient use of data, caches are small relative to the size of the primary storage resource, and often have a limited bandwidth for processing data requests. Thus, when receiving a certain number of data requests, the cache can become saturated. When a cache is saturated, the time it takes to process and respond to data requests can be increased to a point that at least some of the advantage may be lost. In addition, improvements in memory technology may reduce the performance difference between the primary storage resource and the cache memory resource.

### BRIEF DESCRIPTION OF THE DRAWINGS

Features and advantages of example embodiments will be apparent from the detailed description which follows, taken in conjunction with the accompanying drawings, which together illustrate, by way of example, features; and, wherein:

FIG. 1 illustrates an example memory controller in accordance with one example of the present disclosure.

FIG. 2A illustrates an example system in accordance with one example of the present disclosure.

FIG. 2B illustrates an example system in accordance with one example of the present disclosure.

FIG. 2C illustrates an example system in accordance with one example of the present disclosure.

FIG. 3 is a block diagram illustrating an example data storage system 320 that receives requests to write and read data in accordance with one example of the present disclosure.

FIG. 4 is a flowchart illustrating example operations for efficient handling of data requests to a primary memory resource with an associated cache memory resource in accordance with one example of the present disclosure.

FIG. 5 is a flowchart illustrating example operations for efficient handling of data requests to a primary memory resource with an associated cache memory resource in accordance with one example of the present disclosure.

FIG. 6 is a flowchart illustrating example operations for efficient handling of data requests to a primary memory resource with an associated cache memory resource in accordance with one example of the present disclosure.

Reference will now be made to the exemplary embodiments illustrated, and specific language will be used herein to describe the same. It will nevertheless be understood that no limitation on scope is thereby intended.

### DESCRIPTION OF EMBODIMENTS

Before the disclosed example embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various embodiments. One skilled in the relevant art will recognize, however, that such detailed embodiments do not limit the overall inventive concepts articulated herein, but are merely representative thereof.

As used in this specification and the appended claims, the singular forms “a,” “an” and “the” include plural referents unless the context clearly dictates otherwise. Thus, for example, reference to “a bit line” includes a plurality of such bit lines.

Reference throughout this specification to “an example” means that a particular feature, structure, or characteristic described in connection with the example is included in at least one embodiment. Thus, appearances of the phrases “in an example” or “an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples can be referred to herein along with alternatives for the various components thereof. It is understood that such embodiments, examples, and alternatives are not to be construed as de facto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

Numerical amounts and data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

An initial overview of technology embodiments is provided below, and then specific technology embodiments are described in further detail later. This initial summary is intended to aid readers in understanding the technology more quickly, but is not intended to identify key or essential technological features nor is it intended to limit the scope of the claimed subject matter. Unless defined otherwise, all technical and scientific terms used herein have the same meaning as commonly understood by one of ordinary skill in the art to which this disclosure belongs.

Some traditional data storage systems utilize multiple different memory storage technologies in order increase system performance. For example, memory operations can have significantly different latencies depending on the specific memory technology, the memory subsystem architecture, whether the memory operations are read or write operations, and the like. For example, an additional memory tier can be added storage-side to decrease the latency overhead of memory operations to thus increase memory subsystem performance. One technique for implementing an additional memory tier involves using at least two memory resources, one is a primary memory resource and the other as a cache memory resource to store copies of a portion of the contents of the primary memory resource. Depending on the intended design of the memory subsystem, the primary and cache memory resources can be any type of memory technology, technological implementation of memory, or the like. In some examples, the primary and cache memory resources can be the same memory technology, memory type, and/or technological implementation of memory. In other examples, the primary and cache memory resources can be different memory technologies, memory types, and/or technological implementations memory. As such, the primary and cache memory resources can have the same, similar, or different memory performance characteristics. In one specific example, the cache memory resource can be based on a solid-state memory technology and the primary memory resource can be a traditional rotational media technology (e.g., Hard-Disk Drive—HDD). In another example, both the cache memory resource and the primary memory resource can be based on a solid-state memory technology or technologies.

Solid-state nonvolatile memory (NVM) technologies can have significant performance advantages over HDD memory technologies due, at least in part, to the need to mechanically rotate the media to access data. Additionally, different types of solid-state NVM, as well as the associated memory subsystem architecture, can have significantly different performance metrics such as, for example, input/output (I/O) operations per second (TOPS), bandwidth, latency, and the like. Regardless of the source of the performance disparity, in some cases system performance can be increased by using lower performance memory devices, which tend to have larger data volumes, as primary memory resources, and higher performance memory devices as cache memory resources. Various data-handling schemes are contemplated, which can vary depending on the system architecture, the nature of the data operations, and the like. In one example, due to the often greater influence of read latency on system performance, it can be beneficial to direct all cache hits for read requests (i.e., when data requested by the read request is present in the cache memory resource) to the cache memory resource, and all misses for read requests (i.e., when data requested by the read request is not present in the cache memory resource) to the primary memory resource. Such is particularly true when a HDD is used as the primary memory resource.

However, in situations where solid-state NVM technologies are used for both the cache memory resource and the primary memory resource, the difference in performance between the two may be lower. Indeed, in some cases where three-dimensional (3D) cross-point memory is used as a cache memory resource and NAND flash memory is used as a primary memory resource, the primary memory resource may outperform the cache memory resource in some situations with respect to certain performance metrics. Thus, in some cases it may be beneficial to perform certain memory operations, such as data retrieval for example, directly from the primary storage device even when the data is stored in the cache memory resource. For example, when a memory controller receives a data request to retrieve data present in a cache memory resource that is saturated with other data requests, the memory controller can send the data request to the primary memory resource to fetch the data without having to wait in the cache memory resource queue, thus reducing latency by utilizing unused bandwidth available from the primary memory resource. In some examples, the memory controller can estimate a potential delay based on the number of data requests currently queued at the cache memory resource and make a determination as to which memory resource to send the data request. For example, if the potential delay to fetch the data exceeds a threshold delay (e.g., a predetermined delay value), the memory controller can send the data request directly to the primary memory resource and bypass the cache memory resource.

In one example, a memory controller can receive a data request associated with particular data, where the data request is either a read data request or a write data request. For a read data request, the memory controller can perform a lookup of a cache table mapped to the cache memory resource for a copy of the read data (i.e., the particular data for a read request). If the lookup returns a hit, and the copy of the read data is not altered (or dirty) compared to the read data in the primary memory resource, the memory controller can determine whether the cache memory resource is saturated with data requests, or in some cases, whether the saturation of the cache memory resource is greater than a saturation threshold. If the cache memory resource is determined to be saturated, the memory controller can bypass the cache memory resource and send the data request to the primary memory resource to fetch the read data. If, however, the lookup returns a hit, and the copy of the read data is altered (or dirty) compared to the read data in the primary memory resource, the memory controller can send the data request to the cache memory resource in order to fetch the most up-to-date version of the read data.

In a situation where the lookup for a copy of the read data in the cache memory resource returns a miss, the memory controller can bypass the cache memory resource and send the data request to the primary memory resource to fetch the read data. Additionally, in some cases it can be determined whether a copy of the read data should be sent to the cache memory resource according to any number of cache policies. For example, a cache insertion policy can be used to indicate whether or not the read data is to be stored in the cache memory resource, and if so, a copy of the read data can be queued for insertion into the cache memory resource.

If the received data request is a write request, the memory controller can determine whether or not the cache memory resource is saturated with data requests. If it is determined that the cache memory resource is not saturated, the memory controller can send the write request along with the write data (i.e., the particular data for a write request) to the cache memory resource to be written. If, however, it is determined that the cache memory resource is saturated, the memory controller can bypass the cache memory resource and send the write request along with the write data to the primary memory resource to be written. Because the write data would be written regardless of whether or not a copy of the write data was present in the cache memory resource, it is not necessary to perform a lookup of the cache table prior to determining which memory resource to send the write data to. One caveat to writing the data directly to the primary memory resource, however, is the possibility that a copy of the write data is present in the cache memory resource. As such, in situations where the cache resource is saturated, and the write data is sent directly to the primary memory resource, a lookup can be performed in order to locate a cache table entry for a copy of the write data in the cache memory resource. If the lookup returns a hit, the cache table entry of the copy of the write data can be invalidated. In various examples, this write request-related lookup of the cache table can be performed before, during, or after sending the write data to the primary memory resource.

The present disclosure provides novel technology that can be utilized in a system having a primary memory resource and an associated cache memory resource. This technology can be applicable when both the primary data resource and the cache memory resource have the same or different performance characteristics.

In one example, the primary memory resource and the cache memory resource memory store can include volatile memory, NVM, or a combination thereof. Volatile memory can include any type of volatile memory and is not considered to be limiting. Volatile memory is a storage medium that requires power to maintain the state of data stored by the medium. Non-limiting examples of volatile memory can include random access memory (RAM), such as static random-access memory (SRAM), dynamic random-access memory (DRAM), synchronous dynamic random-access memory (SDRAM), and the like, including combinations thereof. SDRAM memory can include any variant thereof, such as single data rate SDRAM (SDR DRAM), double data rate (DDR) SDRAM, including DDR, DDR2, DDR3, DDR4, DDR5, and so on, described collectively as DDRx, and low power DDR (LPDDR) SDRAM, including LPDDR, LPDDR2, LPDDR3, LPDDR4, and so on, described collectively as LPDDRx. In some examples, DRAM complies with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209B for LPDDR SDRAM, JESD209-2F for LPDDR2 SDRAM, JESD209-3C for LPDDR3 SDRAM, and JESD209-4A for LPDDR4 SDRAM (these standards are available at www.jedec.org; DDR5 SDRAM is forthcoming). Such standards (and similar standards) may be referred to as DDR-based or LPDDR-based standards, and communication interfaces that implement such standards may be referred to as DDR-based or LPDDR-based interfaces. In one specific example, the system memory can be DRAM. In another specific example, the system memory can be DDRx SDRAM. In yet another specific aspect, the system memory can be LPDDRx SDRAM.

NVM is a storage medium that does not require power to maintain the state of data stored by the medium. NVM has traditionally been used for the task of data storage, or long-term persistent storage, but new and evolving memory technologies allow the use of NVM in roles that extend beyond traditional data storage. One example of such a role is the use of NVM as main or system memory. Non-volatile system memory (NVMsys) can combine data reliability of traditional storage with ultra-low latency and high bandwidth performance, having many advantages over traditional volatile memory, such as high density, large capacity, lower power consumption, and reduced manufacturing complexity, to name a few. Write-in-place, write-in-place NVM such as three-dimensional (3D) cross-point memory, for example, can operate as write-in-place memory similar to dynamic random-access memory (DRAM), or as block-addressable memory similar to NAND flash. In other words, such NVM can operate as system memory or as persistent storage memory (NVMstor). In some situations where NVM is functioning as system memory, stored data can be discarded or otherwise rendered unreadable when power to the NVMsys is interrupted. NVMsys also allows increased flexibility in data management by providing non-volatile, low-latency memory that can be located closer to a processor in a computing device. In some examples, NVMsys can reside on a DRAM bus, such that the NVMsys can provide ultra-fast DRAM-like access to data. NVMsys can also be useful in computing environments that frequently access large, complex data sets, and environments that are sensitive to downtime caused by power failures or system crashes.

Non-limiting examples of NVM can include planar or three-dimensional (3D) NAND flash memory, including single or multi-threshold-level NAND flash memory, NOR flash memory, single or multi-level Phase Change Memory (PCM), such as chalcogenide glass PCM, planar or 3D PCM, cross-point array memory, including 3D cross-point memory, non-volatile dual in-line memory module (NVDIMM)-based memory, such as flash-based (NVDIMM-F) memory, flash/DRAM-based (NVDIMM-N) memory, persistent memory-based (NVDIMM-P) memory, 3D cross-point-based NVDIMM memory, resistive RAM (ReRAM), including metal-oxide- or oxygen vacancy-based ReRAM, such as HfO2-, Hf/HfOx-, Ti/HfO2-, TiOx-, and TaOx-based ReRAM, filament-based ReRAM, such as Ag/GeS2-, ZrTe/Al2O3-, and Ag-based ReRAM, programmable metallization cell (PMC) memory, such as conductive-bridging RAM (CBRAM), silicon-oxide-nitride-oxide-silicon (SONOS) memory, ferroelectric RAM (FeRAM), ferroelectric transistor RAM (Fe-TRAM), anti-ferroelectric memory, polymer memory (e.g., ferroelectric polymer memory), magnetoresistive RAM (MRAM), write-in-place non -volatile MRAM (NVMRAM), spin-transfer torque (STT) memory, spin-orbit torque (SOT) memory, nanowire memory, electrically erasable programmable read-only memory (EEPROM), nanotube RAM (NRAM), other memristor- and thyristor-based memory, spintronic magnetic junction-based memory, magnetic tunneling junction (MTJ)-based memory, domain wall (DW)-based memory, and the like, including combinations thereof. The term “memory device” can refer to the die itself and/or to a packaged memory product. NVM can be byte or block addressable. In some examples, NVM can comply with one or more standards promulgated by the Joint Electron Device Engineering Council (JEDEC), such as JESD21-C, JESD218, JESD219, JESD220-1, JESD223B, JESD223-1, or other suitable standard (the JEDEC standards cited herein are available at www.jedec.org). In one specific example, the NVM can be 3D cross-point memory. In another specific example, the memory can be NAND or 3D NAND memory. In another specific example, the system memory can be STT memory.

In traditional systems, a memory controller responds to a data request such as a read request, for example, by sending the data request to a cache memory. As a result, when the load of data requests is heavy, the cache memory can become saturated, resulting in an increased response latency. At the same time, the primary memory may have available bandwidth that is unused. Sending memory requests to a cache memory that is saturated when the primary memory has available bandwidth is a nonoptimal situation where the use of a cache memory actually increases response latency. This negative effect is even more pronounced when the storage and retrieval speeds of the cache memory and primary memory are relatively equal.

The present technology, on the other hand, can make a determination as to where a given data request should be sent, whether it be a read request or a write request, depending on the degree of saturation of a cache memory resource. This determination can take into account various factors along with the degree of saturation of the cache memory resource to fill the data request as efficiently as possible, whether it be at the cache memory resource or the primary memory resource. In this manner, the bandwidth of both the cache and the primary memory resource can be fully utilized.

The present technology can provide a number of benefits, including, for example, filling data requests with lower latencies, thus freeing up memory resources for other tasks and improving the performance of a system, or in some cases allowing a system to operate at the same performance level with fewer memory resources. Additionally, by sending a portion of the data requests to the primary memory resource, the degree of saturation of the cache memory resource may be decreased, thus potentially allowing more efficient cache performance. In addition to the effects of lowering latency and increasing bandwidth, the increased efficiency provided by the present technology can lower the power needed to operate the memory storage subsystem.

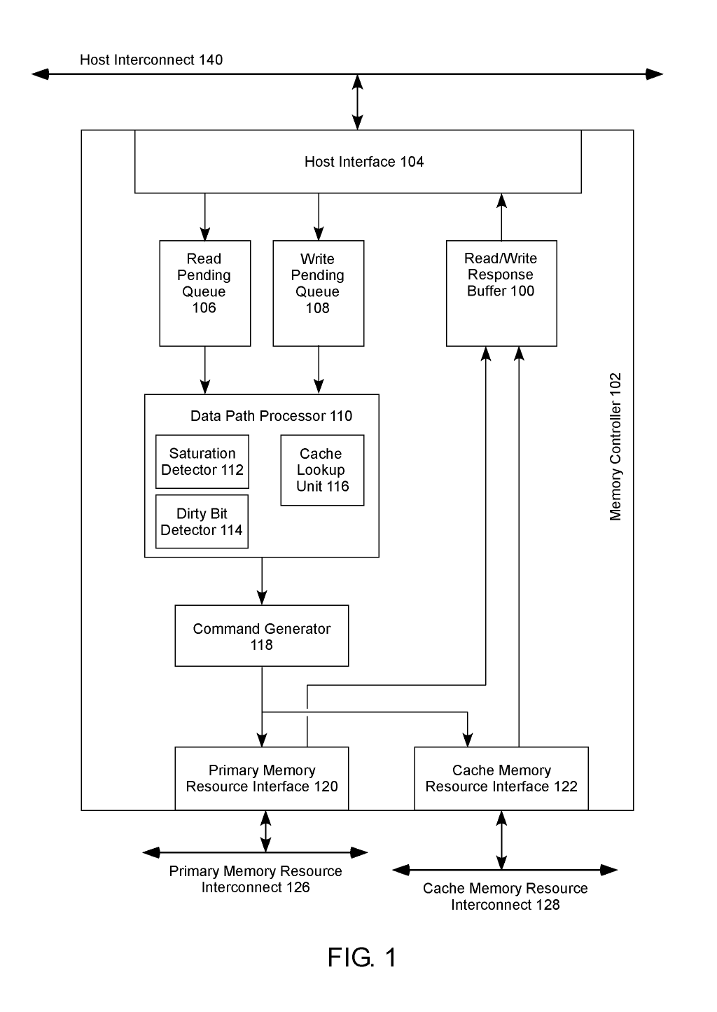

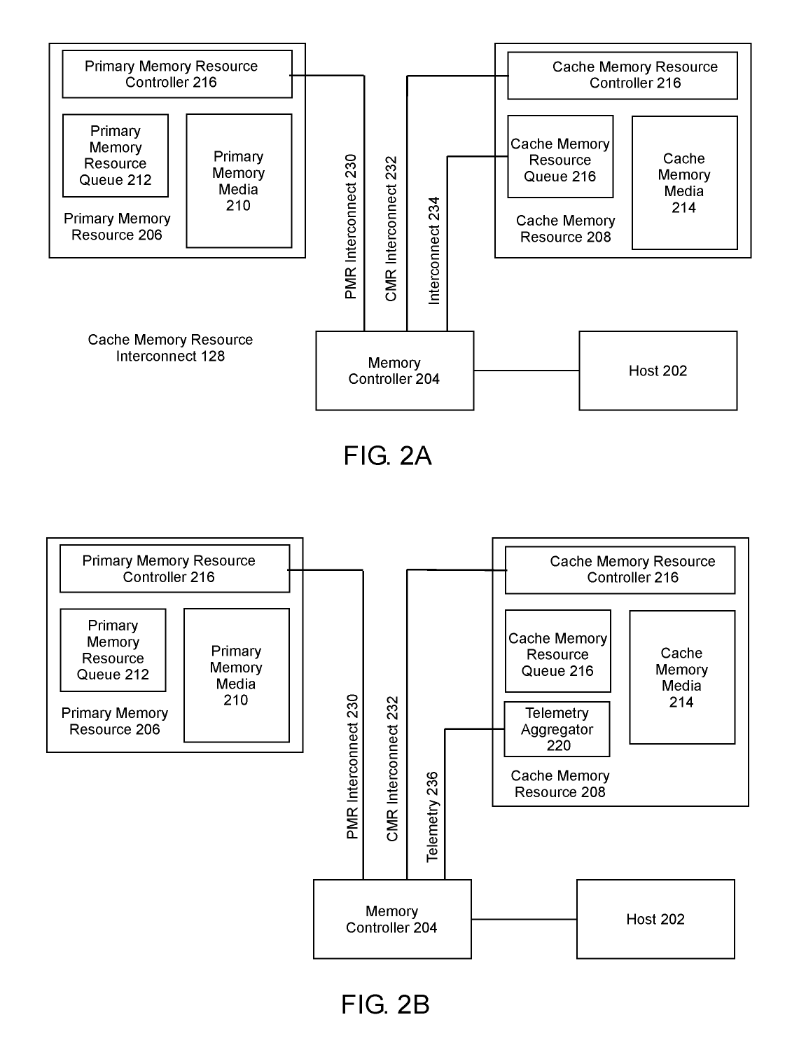

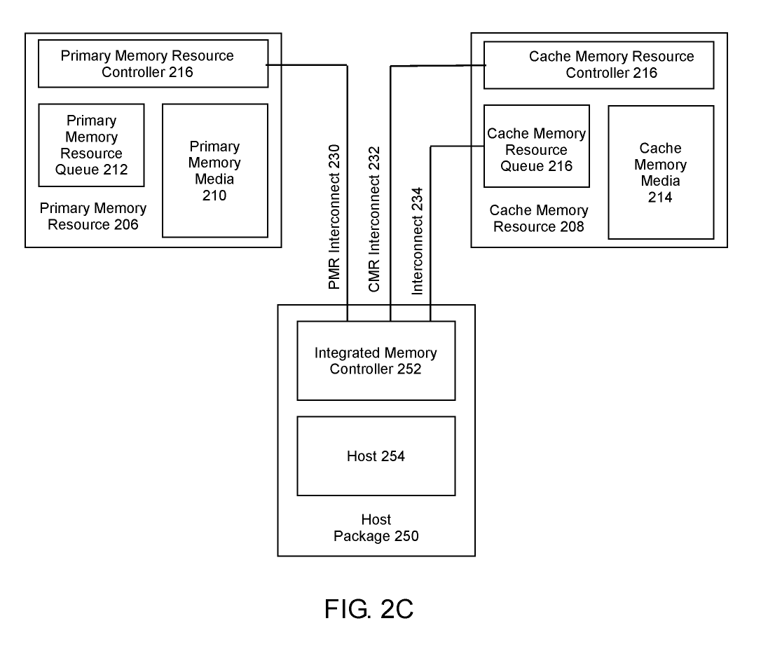

FIG. 1, referencing FIGS. 2A-C, illustrates an example of a memory controller 102 that includes a host interface 104 configured to communicatively couple to a host interconnect 140. The host interface 104 receives data requests from the host interconnect 140, which are queued to either a read pending queue (RPQ) 106 or a write pending queue (WPQ) 108, depending on whether the data request is a read request or a write request. A data path processor 110 is communicatively coupled to each of the RPQ 106 and the WPQ 108, and further includes a saturation detector 112, a dirty bit detector 114, and a cache lookup unit 116. The data path processor 110 is also communicatively coupled to a command generator 118, which generates commands for the data requests to perform read or write memory operations on a primary memory resource 206 or a cache memory resource 208. The memory controller 102 further includes a primary memory resource interface 120 and a cache memory resource interface 122 for communicating with the primary memory resource 206 and the cache memory resource 208 via a primary memory resource interconnect 124 and a cache memory resource interconnect 126, respectively. The cache memory resource 208 and the primary memory resource 206 can include volatile memory, NVM, or a combination thereof.

As has been described, the host interface 104 can be communicatively coupled to the host interconnect 140. The host interconnect 140 can be any type of communication medium, and such can differ depending on the design and/or nature of the system, the level of data traffic, nature of the primary and cache memory resources, and the like. The memory controller can be any type of controller, and can be implemented as an integrated controller at the host, a memory controller in a controller hub apart from the host, a memory or NVM controller at the cache memory resource or the primary memory resource, and the like. Nonlimiting examples of host interconnects can include a front-side bus, a peripheral component interconnect express (PCIe), an Intel® Quick-Path Interconnect (available from Intel Corporation, Santa Clara, Calif.), an in-package interconnect, an in-die interconnect, an Intel® on-chip system fabric (IOSF), a fabric, a direct media interface (DMI), an embedded multi-die interconnect, NVM express (NVMe), and the like. Similarly, the primary memory resource interconnect 126 and the cache memory resource interconnect 128 can be any type of communication medium, and such can differ depending on the design and/or nature of the system, the level of data traffic, nature of the primary and cache memory resources, and the like, including the location and design of the memory controller 102. Nonlimiting examples can include a front-side bus, a peripheral component interconnect express (PCIe), a fabric, a direct media interface (DMI), a universal serial bus (USB), a serial AT attachment (SATA), an external SATA (eSATA), Advanced Host Controller Interface (AHCI), NVMe interface, and the like.

In one example, the memory controller 102 receives a data request associated with particular data from the host interconnect 140 at the host interface 104, where the data request is either a read request or a write request. Read requests can be buffered in a RPQ 106 and write requests can be buffered in a WPQ 108. Once a data request has worked its way through either of the queues, it is received by the data path processor 110. For read requests, the cache lookup unit 116 performs a lookup of current contents of the cache memory resource 330, such as by a lookup of a cache table mapped to the cache memory resource, for example, to determine whether or not a cache table entry for a copy of the data associated with the read request (i.e., the read data) is present. If an entry for the copy of the read data is present, or in other words, if the cache table lookup returns a hit, the data path processor 110 can determine whether the copy of the read data in the cache memory resource 208 has been altered, or in other words, is dirty, compared to the read data in the primary memory resource 206. One technique for tracking such dirty data utilizes a “dirty bit” in the metadata associated with data in cache. As such, the dirty bit detector 114 can check the dirty bit in the metadata of the copy of the read data to determine whether or not the copy of the read data has been altered. If the copy of the read data has not been altered, then the saturation detector 112 can determine whether or not the cache memory resource 208 is saturated, such as with data requests, for example. If the cache memory resource 208 is saturated, or above a threshold level of saturation, the data path processor 110 can bypass the cache memory resource 208 and direct the read request to the primary memory resource 206. The data path processor 110 sends the read request to the command generator 118, which generates the proper read commands to fetch the read data from the primary memory resource 206 through the primary memory resource interconnect 120.

If, on the other hand, a copy of the read data is present in the cache memory resource 208 and the dirty bit detector 114 determines that the copy of the read data is altered, the data path processor 110 can direct the read request to the cache memory resource 208. In such cases, the saturation of the cache memory resource 208 need not be determined, as the dirty read data in the cache memory resource 208 is assumed to be the most recent read data copy, which is used to fill the read request. As such, the data path processor 110 sends the read request to the command generator 118, which generates the proper read commands to fetch the read data from the cache memory resource 206 once the read request has traversed the saturated queue. In those cases, whereby the cache table lookup returns a miss, or in other words, where an entry for a copy of the read data is not present in the cache memory resource 208, the read request is directed through the command generator 118 to the primary memory resource 206. It is noted, however, that in some cases a cache insertion policy may indicate that the read data is to be stored in the cache memory resource 208. In such cases, the data path processor 110 sends can direct a copy of the read data to the cache memory resource 330 for writing.

For write requests, a cache lookup need not be performed initially, as writing to the cache memory resource 208 is not dependent upon whether or not a copy of the associated data to be written (i.e., the write data) is present in the cache memory resource 208. It is noted, however, that in some examples a cache table lookup can be initially performed for write requests. As such, when a write request comes up on the WPQ 108, the saturation detector 112 can determine whether or not the cache memory resource 208 is saturated, such as with data requests, for example. If the cache memory resource 208 is saturated, or above a threshold level of saturation, the data path processor 110 can bypass the cache memory resource 208 and direct the write request and the write data to the primary memory resource 206. The data path processor 110 sends the write request and the write data to the command generator 118, which generates the proper write commands to write the write data to the primary memory resource 206 through the primary memory resource interconnect 120. At some point after determining that the write request will bypass the cache memory resource 208, the cache lookup unit 116 can perform a lookup of the cache table for the cache memory resource 208 to determine whether or not an entry for a copy of the write data is present. A lookup that returns a hit indicates that a copy of the write data is present in the cache memory resource 208. As a result, the memory controller 102 can invalidate the entry for the copy of the write data in the cache table, invalidate the write data in the cache memory resource 208, or both.

If the cache memory resource 208 is not saturated, or is below a threshold level of saturation, the data path processor 110 can direct the write request and the write data to the cache memory resource 208. The data path processor 110 sends the write request to the command generator 118, which generates the proper write commands to write the write data to the cache memory resource 208 through the cache memory resource interconnect 122.

The primary memory resource and the cache memory resource can be any type of storage medium, device, arrangement, configuration, or the like. In some examples, the primary memory resource can be a primary memory resource device, such as a rotational media device, a SSD, a DIMM device, or the like. While the primary memory device can include any of the NVM technologies described above, in one specific example the primary memory device can include write-in-place three-dimensional (3D) cross-point memory. In another specific example, the primary memory device can include NAND flash memory, including 2D NAND, 3D NAND, or a combination thereof. In yet another specific example, the primary memory device can include a DIMM. In a further specific example, the primary memory resource can include a primary memory pool of disaggregated memory devices.

Similarly, in some examples the cache memory resource can be a cache memory resource device, such as a rotational media device, a SSD, a DIMM device, or the like. While the cache memory device can include any of the NVM technologies described above, in one specific example the cache memory device can include write-in-place three-dimensional (3D) cross-point memory. In another specific example, the cache memory device can include NAND flash memory, including 2D NAND, 3D NAND, or a combination thereof In yet another specific example, the cache memory device can include a DIMM. In a further specific example, the cache memory resource can include a primary memory pool of disaggregated memory devices. In some cases, both the primary memory resource can include a DIMM, in some examples where each of the primary and cache memory resources are on a separate DIMM, and in other examples where each of the primary and cache memory resources are on the same DIMM.

FIG. 2A shows a high-level illustration of a system including a host 202 communicatively coupled to a memory controller 204, such as the memory controller 102 shown in FIG. 1, for example, which is further communicatively coupled to a primary memory resource 206 through a primary memory resource (PMR) interconnect 230 and to a cache memory resource 208 through a cache memory resource (CMR) interconnect 232. The primary memory resource 206 can include a primary memory resource controller 216, primary memory media 210, and a primary memory resource queue 212 to buffer read and write requests directed to the primary memory media 210. The cache memory resource 208 can include a cache memory resource controller 216, cache memory media 214, and a cache memory resource queue 216 to buffer the read and write requests directed to the cache memory media 216.

The saturation level of the cache memory resource 208 can be determined or measured according to any number of techniques, and any such technique capable of providing a level or degree of saturation of the cache memory resource 208 is considered to be within the present scope. Nonlimiting examples can include, the number of data request entries present in the cache memory resource queue 216, and the average time that a data request remains in the cache memory resource queue, the average time for a data request to be filled, and the like, including various power, heat, or other resource metric. As such, the saturation determination can be made using information and/or data available at the memory controller 204 or obtained by the memory controller 204 from the cache memory resource 208. For example, saturation of the cache memory resource 208 can increase the time the data request is present in an output buffer of the memory controller 204 waiting to be delivered to cache memory resource 208, and this increase in time can facilitate an indirect determination of saturation. In another example, the memory controller 204 can receive information regarding the cache memory resource queue 216 that facilitates a more direct determination of saturation. As one example, as is shown in FIG. 2A, the memory controller 204 can be configured to query a metric associated with the cache memory resource queue 216 that provide some quantifiable saturation level, such as queue length, for example. In one specific example, memory controller 204 can directly query the cache memory resource queue 216 through an interconnect 234. Interconnect 234 can be the same interconnect as the CMR interconnect 232, can be associated with, but distinct from, the CMR interconnect 232, a completely separate interconnect, or the like. For example, interconnect 234 can be a separate bus, such as an out of band (oob) channel, PECI (Platform Environment Control Interface), system management bus (SMBus), Host Embedded Controller Interface (HECI), or the like.

In other configurations, the memory controller 204 can receive data from the cache memory resource 208 that provides the level or degree of saturation. In one specific example, as shown in FIG. 2B, the memory controller 204 can receive telemetry data from the cache memory resource 208 to facilitate the determination of the saturation level. For example, the cache memory resource 208 can include a telemetry aggregator 220 that is configured to monitor and collect operational data related to saturation of the cache memory resource 208, and to send the operational data to the memory controller 204 via telemetry 236. In another example, the memory controller 204 can utilize information that is generally available to the memory controller 204 to infer that the cache memory resource 208 is saturated, or approaching saturation.

FIG. 2C shows a high-level illustration of a system similar to the system of FIG. 2A, where the memory controller is an integrated memory controller 252 located on a host package 250 with the host 254. In contrast to the configuration of the integrated memory controller 252 querying the cache memory resource queue 216 for the level of saturation, as shown in FIG. 2C, the system of FIG. 2C can receive saturation or operation data from the cache memory resource 208, such as via a telemetry channel from a telemetry aggregator, or any other techniques for providing the saturation data.

As used herein, the term “host” can include any system entity capable of sending a data request to a memory controller, such as, for example, one or more processors, a compute resource, such as a computation pool, a virtual machine, a memory or other controller, or the like. For example, a processor can include general purpose processors, specialized processors such as central processing units (CPUs), graphics processing units (GPUs), digital signal processors (DSPs), microcontrollers (MCUs), microprocessors, embedded controllers (ECs), embedded processors, field programmable gate arrays (FPGAs), network processors, hand-held or mobile processors, application-specific instruction set processors (ASIPs), application-specific integrated circuit (ASIC) processors, co-processors, and the like, as well as base band processors used in transceivers to send, receive, and process wireless communications. Additionally, a processor can be packaged in various configurations, which are not limiting. For example, a processor can be packaged in a common processor package, a multi-core processor package, a system-on-chip (SoC) package, a system-in-package (SiP) package, a system-on-package (SOP) package, and the like.

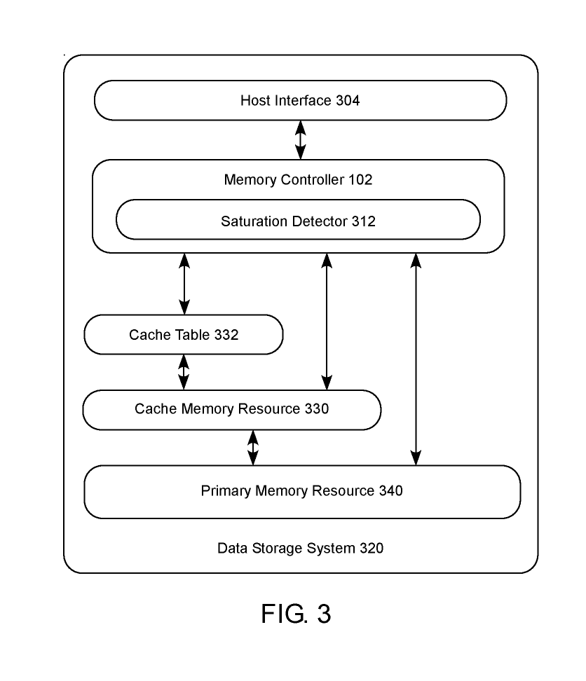

FIG. 3 provides a high-level block diagram illustrating an example data storage system 320 that receives data requests to read and write data. The data storage system 320 can include a host interface 304, a memory controller 302, a cache table 332, a cache memory resource 330, and a primary memory resource 340. The communication interface 304, the memory controller 302, the cache table 332, the cache memory resource 330, and the primary memory resource 340 can be configured to communicate with each other through an internal interconnect, communication bus, fabric, or the like.

In some examples, the memory controller can include a saturation detector 312. The memory controller 302 is configured to receive data requests from one or more hosts or clients. In some examples, requesting hosts can be other components internal to the data storage system, or part of a system in which the data storage system is included. In another example, the memory controller 302 receives data requests from third party systems communicatively coupled to the data storage system 320 through a network.

As has been described, the memory controller 302 can make a determination as to whether the data request is a read request or a write request. A read request generally includes an address to the particular data being requested, and the memory controller 302 can perform a lookup of entries in the cache table 352 to determine whether an entry for the requested data is stored therein. In accordance with a determination that the requested data is stored in the cache memory resource 330, the saturation detector 312 can make a determination as to whether the cache memory resource 330 is saturated.

In one example, saturation can include a situation where the cache memory resource 330 is saturated with data requests to a degree that further data requests cannot be accepted at the cache memory resource 330 and are buffered at the memory controller 302. In another example, saturation can include a situation where the time that a data request remains in input queue of the cache memory resource 330 is greater than a threshold time. As one specific example, if a cache memory resource generally retrieves a 4 KB page in 25 μs, retrieving a 4 KB page in 100 μs may exceed a predetermined threshold, and thus indicate saturation. Thus, if either the memory controller 302 or the cache memory resource 330 determines that saturation of the cache memory resource 330 will cause more than a 100 μs delay in retrieving a 4 KB page, the cache memory resource 330 is classified as saturated.

In accordance with a determination that the cache memory resource 330 is saturated, the memory controller 302 can send the read request directly to the primary memory resource 340, bypassing the cache memory resource 330. Similarly, if the data request is a write request, the saturation detector 312 can determine whether the cache memory resource 330 is saturated and, if so, send the write data request and the associated data to the primary memory resource 340, bypassing the cache memory resource 330.

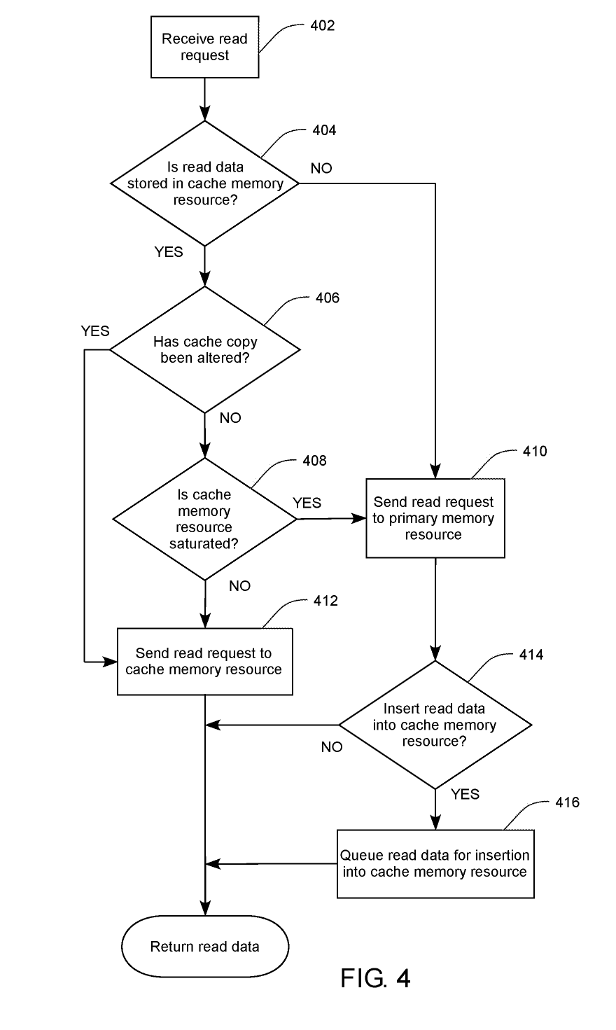

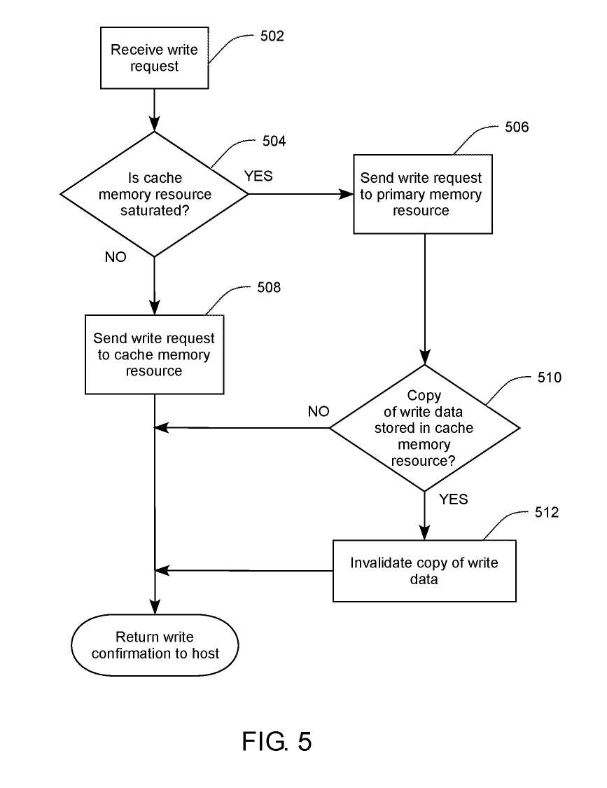

FIG. 4 presents a flowchart illustrating example operations for handling of data requests to a primary memory resource having an associated cache memory resource. In this example, a memory controller receives a read request (402) from a requesting host. The memory controller determines (404) whether a copy of the requested read data is stored in the cache memory resource. In accordance with a determination that a copy of the requested data is not stored in the cache memory resource (e.g., a cache miss), the memory controller sends (410) the read request to the primary memory resource.

In accordance with a determination that a copy of the requested data is stored in the cache memory resource (e.g., a cache hit), the memory controller determines (406) whether the copy of the requested data in the cache memory resource has been altered relative to the read data in the primary memory resource. In some examples, metadata associated with the copy of the read data can include a “dirty bit” to indicate dirty/clean status of the associated data. The dirty bit can be located with the copy of the read data in the cache memory resource, with the entry in the cache table pointing to the read data in the cache memory resource, or both. Because it is an indicator of whether or not any changes made to the copy of the read data have been updated to the read data in the primary memory resource, the memory controller can query the dirty bit to determine whether or not the copy of the read data has been altered.

In accordance with a determination that the requested data has been altered, and that the alterations have not yet been updated to the read data in the primary memory resource, the memory controller sends the read request to the cache memory resource. This can occur regardless of the level of saturation of the cache memory resource in to ensure that the most recent copy of the read data is accessed for the read request. In accordance with a determination that the requested data has not been altered (e.g., the data is “clean”), the memory controller determines (408) whether the cache memory resource is saturated, as has been outlined herein.

In accordance with a determination that the cache memory resource is not saturated, the memory controller can send (412) the read request to the cache memory resource. In accordance with a determination that the cache memory resource is saturated, the memory controller can send the read request (410) directly to the primary memory resource, thus bypassing the cache memory resource. In this way, when the bandwidth of the cache memory resource is limited due to saturation, the memory controller can leverage the bandwidth of the primary memory resource to increase the performance of the memory subsystem.

In the case where the read data is sent to the primary memory resource, the memory controller can apply other caching procedures to the read data according to a standard cache insertion policy, for example, and can thus determine (414) whether the read data should be inserted into the cache memory resource. In accordance with a determination that the read data should be inserted into the cache memory resource, the memory controller queues (416) the read data for insertion into the cache memory resource 330. Once the requested read data is retrieved, either from the cache memory resource or from the primary memory resource, the memory controller can transmit the read data to the requestor.

FIG. 5 presents a flowchart illustrating example operations for handling of data requests to a primary memory resource having an associated cache memory resource. In this example, a memory controller receives (502) a write request from a requesting host. The memory controller determines whether (504) the cache memory resource is saturated. In accordance with a determination that the cache memory resource is saturated, the memory controller sends (506) the write request to the primary memory resource and the primary memory resource performs the write request. In accordance with a determination that the cache memory resource is not saturated, the memory controller sends (508) the write request to the cache memory resource, which performs the write request. In some examples where the write request is sent to the primary memory resource, the memory controller determines (510) whether a copy of the write data is stored in the cache memory resource. In response to a determination that a copy of the write data is present in the cache memory resource, the memory controller can invalidate the copy of the write data in the cache memory resource (and/or in the associated cache table) or otherwise update the cache memory resource and/or cache table.

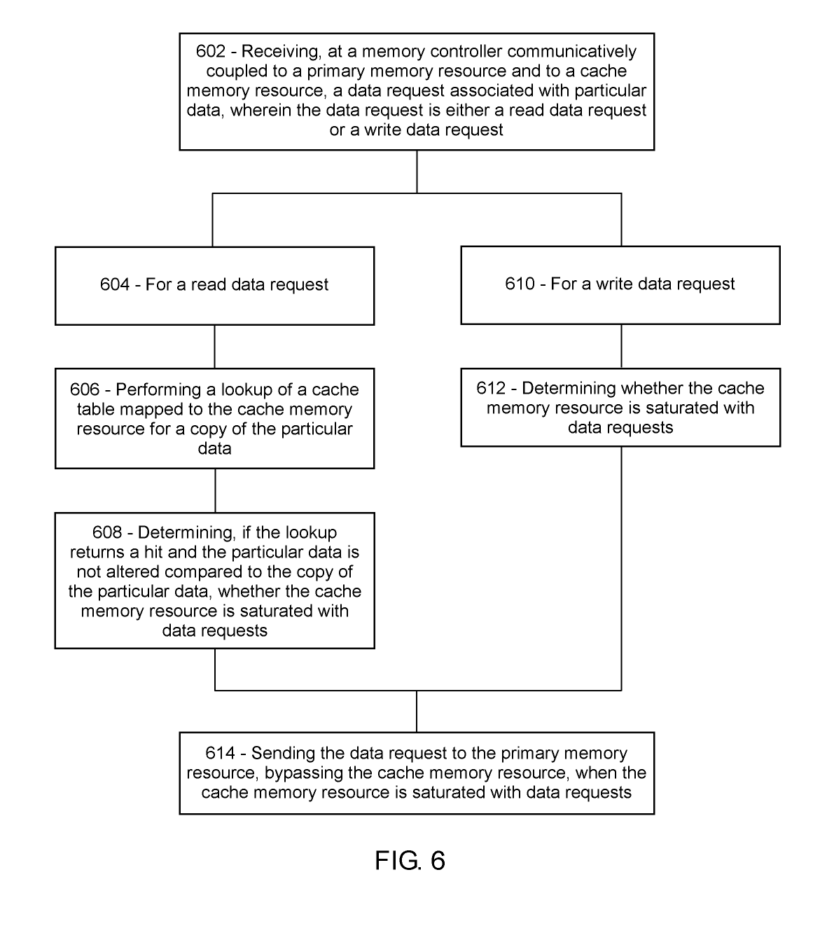

FIG. 6 shows one example of a method for increasing memory bandwidth by utilizing unused bandwidth from a primary memory resource. Such a method can include receiving (602), at a memory controller communicatively coupled to a primary memory resource and to a cache memory resource, a data request associated with particular data, wherein the data request is either a read data request or a write data request. For a read data request (604), the method further comprises performing (606) a lookup of a cache table mapped to the cache memory resource for a copy of the particular data, and determining (608), if the lookup returns a hit and the particular data is not altered compared to the copy of the particular data, whether the cache memory resource is saturated with data requests. For a write data request (610), the method further comprises determining (612) whether the cache memory resource is saturated with data requests. The method can further include, for both read and write requests, sending (614) the data request to the primary memory resource, bypassing the cache memory resource, when the cache memory resource is saturated with data requests.

In one example, where the data request is a read data request, the lookup returns a hit, and the particular data is altered compared to the copy of the particular data, the method can further include sending the read request to the cache memory resource. In yet another example, for a read data request where the lookup returns a miss, the method further comprises sending the data request to the primary memory resource, bypassing the cache memory resource. In a further example, for a read data request where the lookup returns a miss and a cache insertion policy indicates that the associated data is to be stored in the cache memory resource, the method further comprises sending the data request to the cache memory resource.

In another example, where the data request is a write data request and the cache memory resource is not saturated, the method further comprises sending the data request to the cache memory resource. In yet another example, where the data request is a write data request and the cache memory resource is saturated, the method further comprises performing a lookup of a cache table mapped to the cache memory resource for an entry of a copy of the particular data, and invalidating the entry of the copy of the particular data in the cache table in response to the lookup returning a hit.

In another example, a general computing system is provided that can incorporate the present technology. While any type or configuration of device or computing system is contemplated to be within the present scope, non-limiting examples can include node computing systems, SoC systems, SiP systems, SoP systems, server systems, networking systems, high capacity computing systems, laptop computers, tablet computers, desktop computers, smart phones, or the like.

The computing system can include one or more processors in communication with a memory. The memory can include any device, combination of devices, circuitry, or the like, that is capable of storing, accessing, organizing, and/or retrieving data. Additionally, various communication interconnects can provide connectivity between the various components of the system. The communication interface can vary widely depending on the processor, chipset, and memory architectures of the system. For example, the communication interface can be a local data bus, command/address buss, package interface, fabric, or the like.

The computing system can also include an I/O (input/output) interface for controlling the I/O functions of the system, as well as for I/O connectivity to devices outside of the computing system. A network interface can also be included for network connectivity. The network interface can control network communications both within the system and outside of the system, and can include a wired interface, a wireless interface, a Bluetooth interface, optical interface, communication fabric, and the like, including appropriate combinations thereof. Furthermore, the computing system can additionally include a user interface, a display device, as well as various other components that would be beneficial for such a system.

The processor can be a single processor or multiple processors, including single or multiple processor cores, and the memory can be a single or multiple memories. The communication interconnect can be used as a pathway to facilitate communication between any of a single processor or processor cores, multiple processors or processor cores, a single memory, multiple memories, the various interfaces, and the like, in any useful combination. In some examples, the communication interface can be a separate interface between the processor and one or more other components of the system, such as, for example, the memory. The memory can include system memory that is volatile, nonvolatile, or a combination thereof, as described herein. The memory can additionally include NVM utilized as a memory store.

Various techniques, or certain aspects or portions thereof, can take the form of program code (i.e., instructions) embodied in tangible media, such as CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data. The node and wireless device can also include a transceiver module, a counter module, a processing module, and/or a clock module or timer module. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations. Exemplary systems or devices can include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

### EXAMPLES

The following examples pertain to specific example embodiments and point out specific features, elements, or steps that can be used or otherwise combined in achieving such embodiments.

In one example, there is provided a memory storage control apparatus, comprising a memory controller configured to communicatively couple to a primary memory resource and to a cache memory resource, where the memory controller includes circuitry configured to receive a data request associated with particular data, where the data request is either a read data request or a write data request. For a read data request, the circuitry is further configured to perform a lookup of a cache table mapped to the cache memory resource for a copy of the particular data and determine, if the lookup returns a hit and the particular data is not altered compared to the copy of the particular data, whether the cache memory resource is saturated with data requests. For a write data request, the circuitry is further configured to determine whether the cache memory resource is saturated with data requests. Additionally, in accordance with a determination that the cache memory resource is saturated with data requests, the circuitry is configured to bypass the cache memory resource, and send the data request to the primary memory resource.

In one example, the apparatus can further comprise the cache table.

In one example apparatus, the cache table is external to the cache memory resource.

In one example apparatus, the cache table is internal to the cache memory resource.

In one example apparatus, for a read data request where the lookup returns a hit and the particular data is altered compared to the copy of the particular data, the circuitry is further configured to send the data request to the cache memory resource.

In one example apparatus, for a read data request where the lookup returns a miss, the circuitry is further configured to bypass the cache memory resource and send the data request to the primary memory resource.

In one example apparatus, for a write data request where the cache memory resource is not saturated, the circuitry is further configured to send the data request to the cache memory resource.

In one example apparatus, for a write data request where the cache memory resource is saturated, the circuitry is further configured to perform a lookup of a cache table mapped to the cache memory resource for an entry of a copy of the particular data, and invalidate the entry of the copy of the particular data in the cache table in response to the lookup returning a hit.

In one example, the apparatus further comprises the primary memory resource and the cache memory resource.

In one example apparatus, the primary memory resource is a primary memory device. In one example apparatus, the primary memory device comprises write-in-place three-dimensional (3D) cross-point memory.

In one example apparatus, the primary memory device comprises NAND flash memory.

In one example apparatus, the primary memory device is a dual in-line memory module (DIMM) and the cache memory resource is a cache memory device coupled on the DIMM.

In one example apparatus, the primary memory resource is a primary memory pool of disaggregated memory devices.

In one example apparatus, the cache memory resource is a cache memory device. In one example apparatus, the cache memory device comprises write-in-place three-dimensional (3D) cross-point memory.

In one example apparatus, the cache memory device comprises NAND flash.

In one example apparatus, the cache memory resource is a cache memory pool of disaggregated memory devices.

In one example, there is provided a data storage system, comprising a primary memory resource, a cache memory resource, and a memory controller communicatively coupled to the primary memory resource and to the cache memory resource, the memory controller including circuitry configured to receive a data request associated with particular data, wherein the data request is either a read data request or a write data request. For a read data request, the circuitry is further configured to perform a lookup of a cache table mapped to the cache memory resource for a copy of the particular data and determine, if the lookup returns a hit and the particular data is not altered compared to the copy of the particular data, whether the cache memory resource is saturated with data requests. For a write data request, the circuitry is further configured to determine whether the cache memory resource is saturated with data requests. Additionally, in accordance with a determination that the cache memory resource is saturated with data requests, the circuitry is configured to bypass the cache memory resource and send the data request to the primary memory resource.

In one example, the system further comprises the cache table.

In one example system, the cache table is external to the cache memory resource.

In one example system, the cache table is internal to the cache memory resource. In one example system, for a read data request where the lookup returns a hit and the particular data is altered compared to the copy of the particular data, the circuitry is further configured to send the data request to the cache memory resource.

In one example system, for a read data request where the lookup returns a miss, the circuitry is further configured to bypass the cache memory resource and send the data request to the primary memory resource.

In one example system, for a read data request where the lookup returns a miss and a cache insertion policy indicates that the associated data is to be stored in the cache memory resource, the circuitry is further configured to send the data request to the cache memory resource.

In one example system, for a write data request where the cache memory resource is not saturated, the circuitry is further configured to send the data request to the cache memory resource.

In one example system, for a write data request where the cache memory resource is saturated, the circuitry is further configured to perform a lookup of a cache table mapped to the cache memory resource for an entry of a copy of the particular data and invalidate the entry of the copy of the particular data in the cache table in response to the lookup returning a hit. In one example system, the primary memory resource is a primary memory device. In one example system, the primary memory device comprises write-in-place three-dimensional (3D) cross-point memory.

In one example system, the primary memory device comprises NAND flash memory.

In one example system, the primary memory device is a dual in-line memory module (DIMM) and the cache memory resource is a cache memory device coupled on the DIMM.

In one example system, the primary memory resource is a primary memory pool of disaggregated memory devices.

In one example system, the cache memory resource is a cache memory device. In one example system, the cache memory device comprises write-in-place three-dimensional (3D) cross-point memory.

In one example system, the cache memory device comprises NAND flash memory.

In one example system, the cache memory resource is a cache memory pool of disaggregated memory devices.

In one example, there is provided a method of increasing memory bandwidth, comprising receiving, at a memory controller communicatively coupled to a primary memory resource and to a cache memory resource, a data request associated with particular data, wherein the data request is either a read data request or a write data request. For a read data request, the method further comprises performing a lookup of a cache table mapped to the cache memory resource for a copy of the particular data and determining, if the lookup returns a hit and the particular data is not altered compared to the copy of the particular data, whether the cache memory resource is saturated with data requests. For a write data request, the method further comprises determining whether the cache memory resource is saturated with data requests. Additionally, the method further comprises sending the data request to the primary memory resource, bypassing the cache memory resource, when the cache memory resource is saturated with data requests.

In one example method, for a read data request where the lookup returns a hit and the particular data is altered compared to the copy of the particular data, the method further comprises sending the data request to the cache memory resource.

In one example method, for a read data request where the lookup returns a miss, the method further comprises sending the data request to the primary memory resource, bypassing the cache memory resource.

In one example method, for a read data request where the lookup returns a miss and a cache insertion policy indicates that the associated data is to be stored in the cache memory resource, the method further comprises sending the data request to the cache memory resource.

In one example method, for a write data request where the cache memory resource is not saturated, the method further comprises sending the data request to the cache memory resource.

In one example method, for a write data request where the cache memory resource is saturated, the method further comprises performing a lookup of a cache table mapped to the cache memory resource for an entry of a copy of the particular data and invalidating the entry of the copy of the particular data in the cache table in response to the lookup returning a hit.

While the forgoing examples are illustrative of the principles of example embodiments in one or more particular applications, it will be apparent to those of ordinary skill in the art that numerous modifications in form, usage and details of implementation can be made without the exercise of inventive faculty, and without departing from the principles and concepts of the disclosure.

What is claimed is:

1. A memory storage control apparatus, comprising:
a memory controller configured to communicatively couple to a primary memory resource and to a cache memory resource, the memory controller including circuitry configured to:
receive a read data request associated with particular data;
perform a lookup of a cache table mapped to the cache memory resource for a copy of the particular data; and
determine, if the lookup returns a hit and the particular data is not altered compared to the copy of the particular data, whether the cache memory resource is saturated with data requests; and
in accordance with a determination that the cache memory resource is saturated with data requests, bypass the cache memory resource, and send the data request to the primary memory resource.

2. The apparatus of claim 1, wherein, where the lookup returns a hit and the particular data is altered compared to the copy of the particular data, the circuitry is further configured to send the data request to the cache memory resource.

3. The apparatus of claim 1, further comprising the primary memory resource and the cache memory resource.

4. The apparatus of claim 3, wherein the primary memory resource is a primary memory device and the cache memory resource is a cache memory device.

5. The apparatus of claim 3, wherein the primary memory resource is a primary memory pool of disaggregated memory devices and the cache memory resource is a cache memory pool of disaggregated memory devices.

6. A memory storage control apparatus, comprising:
a memory controller configured to communicatively couple to a primary memory resource and to a cache memory resource, the memory controller including circuitry configured to:
receive a write request associated with particular data;
determine whether the cache memory resource is saturated with data requests; and
in accordance with a determination that the cache memory resource is saturated with data requests, bypass the cache memory resource, and send the data request to the primary memory resource.

7. The apparatus of claim 6, wherein, where the cache memory resource is saturated, the circuitry is further configured to:
perform a lookup of a cache table mapped to the cache memory resource for an entry of a copy of the particular data; and
invalidate the entry of the copy of the particular data in the cache table in response to the lookup returning a hit.

8. The apparatus of claim 1, further comprising the primary memory resource and the cache memory resource.

9. The apparatus of claim 8, wherein the primary memory resource is a primary memory device and the cache memory resource is a cache memory device.

10. The apparatus of claim 8, wherein the primary memory resource is a primary memory pool of disaggregated memory devices and the cache memory resource is a cache memory pool of disaggregated memory devices.

11. A data storage system, comprising:
a primary memory resource;
a cache memory resource; and
a memory controller communicatively coupled to the primary memory resource and to the cache memory resource, the memory controller including circuitry configured to:
receive a read data request associated with particular data;
perform a lookup of a cache table mapped to the cache memory resource for a copy of the particular data; and
determine, if the lookup returns a hit and the particular data is not altered compared to the copy of the particular data, whether the cache memory resource is saturated with data requests; and
in accordance with a determination that the cache memory resource is saturated with data requests, bypass the cache memory resource, and send the data request to the primary memory resource.

12. The system of claim 11, wherein, where the lookup returns a hit and the particular data is altered compared to the copy of the particular data, the circuitry is further configured to send the data request to the cache memory resource.

13. The system of claim 11, wherein the primary memory resource is a primary memory device and the cache memory resource is a cache memory device.

14. The system of claim 11, wherein at least one of the primary memory resource or the cache memory resource comprises write-in-place three-dimensional (3D) cross-point memory.

15. The system of claim 11, wherein at least one of the primary memory resource or the cache memory resource comprises NAND flash memory.

16. The system of claim 11, wherein at least one of the primary memory resource or the cache memory resource is a dual in-line memory module (DIMM).

17. The system of claim 11, wherein at least one of the primary memory resource or the cache memory resource is a memory pool of disaggregated memory devices.

18. A data storage system, comprising:
a primary memory resource;
a cache memory resource; and
a memory controller communicatively coupled to the primary memory resource and to the cache memory resource, the memory controller including circuitry configured to:
receive a write request associated with particular data;
determine whether the cache memory resource is saturated with data requests; and
in accordance with a determination that the cache memory resource is saturated with data requests, bypass the cache memory resource, and send the data request to the primary memory resource.

19. The system of claim 18, wherein, where the cache memory resource is saturated, the circuitry is further configured to:
perform a lookup of a cache table mapped to the cache memory resource for an entry of a copy of the particular data; and
invalidate the entry of the copy of the particular data in the cache table in response to the lookup returning a hit.

20. The system of claim 18, wherein the primary memory resource is a primary memory device and the cache memory resource is a cache memory device.

21. The system of claim 18, wherein at least one of the primary memory resource or the cache memory resource comprises write-in-place three-dimensional (3D) cross-point memory.

22. The system of claim 18, wherein at least one of the primary memory resource or the cache memory resource comprises NAND flash memory.

23. The system of claim 18, wherein at least one of the primary memory resource or the cache memory resource is a dual in-line memory module (DIMM).

24. The system of claim 18, wherein at least one of the primary memory resource or the cache memory resource is a memory pool of disaggregated memory devices.
